(19) United States
(12) Patent Application Publication
(10) Pub. No.: US 2010/0190074 A1
(43) Pub. Date: Jul. 29, 2010

(54) FUEL CELL SYSTEM AND VOLTAGE LIMITATION METHOD

(75) Inventors: Jusuke Shimura, Kanagawa (JP); Yoshiaki Inoue, Aichi (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/678,340

(22) PCT Filed: Sep. 18, 2008
(86) PCT No.: PCT/JP2008/066839

§ 371 Date: Mar. 16, 2010

(30) Foreign Application Priority Data
Sep. 19, 2007 (JP) P2007-242527

(51) Int. Cl. H01M 8/04

(52) U.S. Cl. 429/432

(57) ABSTRACT

A fuel cell system with which elution of a cathode due to excessive electro motive force is able to be inhibited without increase of electric power consumption at the time of power generation is provided. In the case where electro motive force V1 by a power generation section 10 exceeds a given threshold voltage Vp at which elution of a cathode of respective unit cells 10A to 10F is generated, electric power based on a voltage ΔV for an excess portion over the threshold voltage is heat-consumed in a voltage limitation circuit 3, and thereby the electro motive force V1 of the power generation section 10 is limited to the threshold voltage Vp or less. The voltage limitation circuit includes a zener diode, a shunt regulator, a transistor or the like.

### TECHNICAL FIELD

The present invention relates to a fuel cell system in which power generation is performed by reaction between methanol or the like and oxygen and a voltage limitation method applied to such a fuel cell system.

### BACKGROUND ART

In the past, since fuel batteries have high power generation efficiency and do not exhaust harmful matter, the fuel batteries have been practically used as an industrial power generation equipment and a household power generation equipment, or as a power source for an artificial earth satellite, a space ship or the like. Further, in recent years, the fuel batteries have been progressively developed as a power source for a vehicle such as a passenger car, a bus, and a cargo truck. Such fuel batteries are categorized into an alkali aqueous solution fuel cell, a phosphoric-acid fuel cell, a molten carbonate fuel cell, a solid oxide fuel cell, a direct methanol fuel cell and the like. Specially, a solid polyelectrolyte DMFC (Direct Methanol Fuel Cell) is able to provide a high energy density by using methanol as a fuel hydrogen source. Further, the DMFC does not need a reformer and thus is able to be downsized. Thus, the DMFC as a small mobile fuel cell has been progressively researched.

In the DMFC, an MEA (Membrane Electrode Assembly) as a unit cell in which a solid polyelectrolyte film is sandwiched between two electrodes, and the resultant is jointed and integrated is used. One gas diffusion electrode is used as a fuel electrode (anode), and methanol as a fuel is supplied to the surface of such one gas diffusion electrode. In result, the methanol is decomposed, hydrogen ions (protons) and electrons are generated, and the hydrogen ions pass through the solid polyelectrolyte film. Further, the other gas diffusion electrode is used as an oxygen electrode (cathode), and air as an oxidant is supplied to the surface of the other gas diffusion electrode. In result, oxygen in the air is bonded with the foregoing hydrogen ions and the foregoing electrons to generate water. Such electrochemical reaction results in generation of electro motive force from the DMFC.

In such a fuel cell, in the past, technologies with which electro motive force is able to be limited for the various purposes have been proposed (for example, Patent Documents 1 to 5).

[Patent Document 1] Japanese Unexamined Patent Application Publication No. 59-75570
[Patent Document 2] Japanese Unexamined Patent Application Publication No. 3-141560

[Patent Document 3] Japanese Unexamined Patent Application Publication No. 2003-115305

[Patent Document 4] Japanese Unexamined Patent Application Publication No. 2004-319437

[Patent Document 5] Japanese Unexamined Patent Application Publication No. 2006-196452

### DISCLOSURE OF INVENTION

In the foregoing Patent Documents 1 and 2, for the purpose of preventing short circuit of a battery body, a circuit in which electro motive force by all unit cells does not exceed a given voltage (for example, the maximum absolute rated voltage) is proposed. In particular, in Patent Documents 1, in the case where the electro motive force by the all unit cells exceeds the given voltage, a short circuit route is formed by a thyristor or the like to consume electric power, and thereby the electro motive force is prevented from exceeding the given voltage.

Further, in the foregoing Patent Document 3, a circuit in which corrosion of a separator for jointing unit cells is prevented by inhibiting generation of an open circuit voltage is proposed.

Examples of major causes of deteriorating a fuel cell include electrode elution phenomenon. In such phenomenon, after long-term usage, the electrode is oxidized to become ions, which are eluted outside. Such elution phenomenon is generated more significantly as electrode potential is higher. Thus, in particular, elution of a cathode having high potential (for example, platinum) is serious.

To theoretically study a method to inhibit such electrode elution, for example, the Pourbaix Diagram as illustrated in FIG. 12 serves as a reference. The Pourbaix Diagram is derived from Nernst's equation, and a diagram thermodynamically illustrating a stable oxidation state in certain pH and a certain potential. According to the Pourbaix Diagram, it is found that in order to inhibit elution of platinum composing the cathode (avoid a state of platinum ions), pH should be lowered, or potential of the cathode should be lowered.

However, the former method of lowering pH is difficult to be adopted practically, since adjusting pH is difficult because an alternative material of Nafion (registered trademark) mainly used as an electrolyte film is hardly applied.

Meanwhile, the latter method of lowering the potential of the cathode is comparatively easily realized compared to the former method. FIG. 13 illustrates a current-voltage curved line (illustrating relation between a current and a cathode potential/an anode potential/a potential difference (voltage) between a cathode and anode/an output) in a direct methanol fuel cell. According to FIG. 13, the cathode potential is not always high. Only in the case of a region where the current is small (region 2 out of regions 1 and 2 in the figure), it becomes in a state of high potential in which elution becomes problematic (0.85 [V vs. SHE (Standard hydrogen electrode)] or more). That is, in the region 1 used in practically steady power generation, the cathode potential is not high originally. Thus, it is found that in order to keep the cathode potential low (low potential state: 0.85 [V vs. SHE] or less), it is sufficiently enough to exercise “control to avoid a state of the region 2.” In addition, from FIG. 13, it is found that it is sufficiently enough that in the case of the direct methanol fuel cell, the potential difference between the cathode potential and the anode potential, that is, the power generation voltage is kept 0.33 V or less.

For example, Patent Document 4 proposes a method to prevent elution of the cathode by avoiding the state of the region 2 by controlling operation temperature and a fuel concentration. However, to adopt the method, a sensor of the fuel concentration is necessitated. Further, in order to obtain “control to avoid a state of the region 2,” the operation temperature and the fuel concentration should be always monitored continuously. Thus, it causes increase of electric power consumption in the control circuit. In result, it leads to performance lowering in the whole fuel cell system.

Further, as another method, for example, Patent Document 5 proposes a chemical method to add a hardly soluble (small solubility product) metal salt to a member in the vicinity of a cathode. Since this method is unrelated to the control circuit, increase of electric power consumption as in the method of the foregoing Patent Document 4 does not occur. However, since so-called impurity that is not originally necessary for chemical reaction of the fuel cell is added, it may lead to performance lowering of the fuel cell itself

As described above, in the existing fuel cell, it is difficult to inhibit elution of the cathode due to excessive electro motive force (high potential) without increase of electric power consumption at the time of power generation.

In view of the foregoing disadvantage, it is an object of the present invention to provide a fuel cell system with which elution of the cathode due to excessive electro motive force is able to be inhibited without increase of electric power consumption at the time of power generation and a voltage limitation method.

A fuel cell system of the present invention includes a power generation section including a unit cell having a cathode (oxygen electrode) and an anode (fuel electrode); and a voltage limitation circuit. The voltage limitation circuit is connected in parallel to the power generation section. In the case where electro motive force by the power generation section exceeds a given threshold voltage at which elution of the cathode is generated, the voltage limitation circuit heat-consumes electric power based on a voltage for an excess portion over the threshold voltage, and thereby limits the electro motive force of the power generation section to the threshold voltage or less.

A voltage limitation method of the present invention is applied to a fuel cell system that includes a power generation section including a unit cell having a cathode (oxygen electrode) and an anode (fuel electrode). In the voltage limitation method, with the use of a voltage limitation circuit that is connected in parallel to the power generation section, in the case where electro motive force by the power generation section exceeds a given threshold voltage at which elution of the cathode is generated, electric power based on a voltage for an excess portion over the threshold voltage is heat-consumed, and thereby the electro motive force of the power generation section is limited to the threshold voltage or less.

In the fuel cell system and the voltage limitation method of the present invention, in the case where the electro motive force by the power generation section exceeds the given threshold voltage at which elution of the cathode is generated, the electric power based on the voltage for the excess portion over the threshold voltage is heat-consumed by the voltage limitation circuit, and thereby the electro motive force of the power generation section is limited to the threshold voltage or less. Further, in such voltage limitation operation, it is not necessary to constantly monitor the temperature, the fuel concentration, the voltage and the like as in the existing case. Thus, increase of electric power consumption at the time of power generation is not caused.

According to the fuel cell system or the voltage limitation method of the present invention, in the case where the electro motive force by the power generation section exceeds the given threshold voltage at which elution of the cathode is generated, the electric power based on the voltage for the excess portion over the threshold voltage is heat-consumed, and thereby the electro motive force of the power generation section is limited to the threshold voltage or less. Thus, high potential of the cathode by excessive electro motive force is inhibited without causing increase of electric power consumption at the time of power generation, and thereby elution of the cathode is able to be inhibited.

### BRIEF DESCRIPTION OF DRAWINGS

FIG. 1 is a circuit diagram illustrating a whole structure of a fuel cell system according to a first embodiment of the present invention.

FIG. 2 is a cross sectional view illustrating a structural example of the power generation section illustrated in FIG. 1.

FIG. 3 is a plan view illustrating a structural example of the power generation section illustrated in FIG. 1.

FIG. 4 is a cross sectional view for explaining a method of manufacturing the power generation section illustrated in FIG. 1.

FIG. 5 is a plan view for explaining the method of manufacturing the power generation section illustrated in FIG. 1.

FIG. 6 is a circuit diagram illustrating a whole structure of a fuel cell system according to a modified example of the first embodiment.

FIG. 7 is a circuit diagram illustrating a whole structure of a fuel cell system according to a second embodiment.

FIG. 8 is circuit diagram illustrating a whole structure of a fuel cell system according to a third embodiment.

FIG. 9 is a circuit diagram illustrating a whole structure of a fuel cell system according to a modified example of the third embodiment.

FIG. 10 is a circuit diagram illustrating a whole structure of a fuel cell system according to another modified example of the third embodiment.

FIG. 11 is a circuit diagram illustrating a whole structure of a fuel cell system according to another modified example of the third embodiment;

FIG. 12 is a characteristics diagram illustrating Pourbaix Diagram (relation diagram between pH and a potential) in platinum.

FIG. 13 is a characteristics diagram illustrating an example of relation between a current density and voltage/output density in a fuel cell.

### BEST MODE(S) FOR CARRYING OUT THE INVENTION

Embodiments of the present invention will be hereinafter described in detail with reference to the drawings.

### First Embodiment

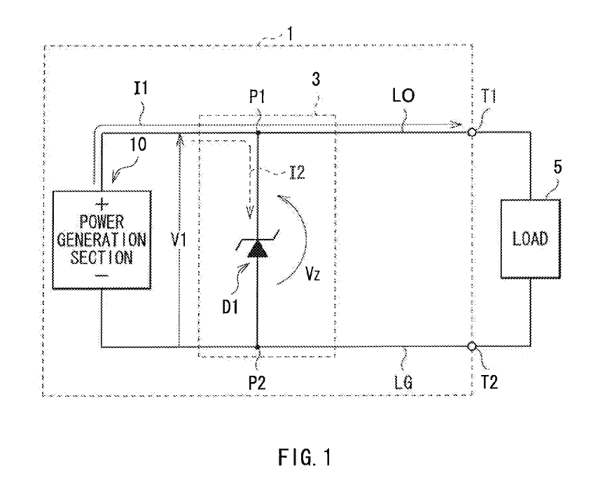

FIG. 1 illustrates a whole structure of a fuel cell system (fuel cell system 1) according to a first embodiment of the present invention. The fuel cell system 1 supplies electric power through output terminals T1 and T2 to drive a load 5. The fuel cell system 1 is composed of, for example, a power generation section 10 to generate electro motive force V1 and a voltage limitation circuit 3 as a circuit to limit the electro motive force V1 to a given voltage (threshold voltage described later) or less.

The power generation section 10 is a direct methanol power generation section for performing power generation by reaction between methanol and oxygen. The power generation section 10 includes a plurality of unit cells having a cathode (oxygen electrode) and an anode (fuel electrode). For the detailed structure of the power generation section 10, a description will be given later.

The voltage limitation circuit 3 is electrically connected in parallel to the power generation section 10, and is composed of one zener diode D1. Specifically, a cathode of the zener diode D1 is connected to the cathode side of the power generation section through a connection point P1 and an output line L0, and an anode of the zener diode D1 is connected to the anode side of the power generation section 10 through a connection point P2 and a ground line LG Further, a breakdown voltage (zener voltage) Vz of the zener diode D1 is almost equal to a threshold voltage Vp of the electro motive force V1 described later, and is, for example, 0.33 V per unit cell.

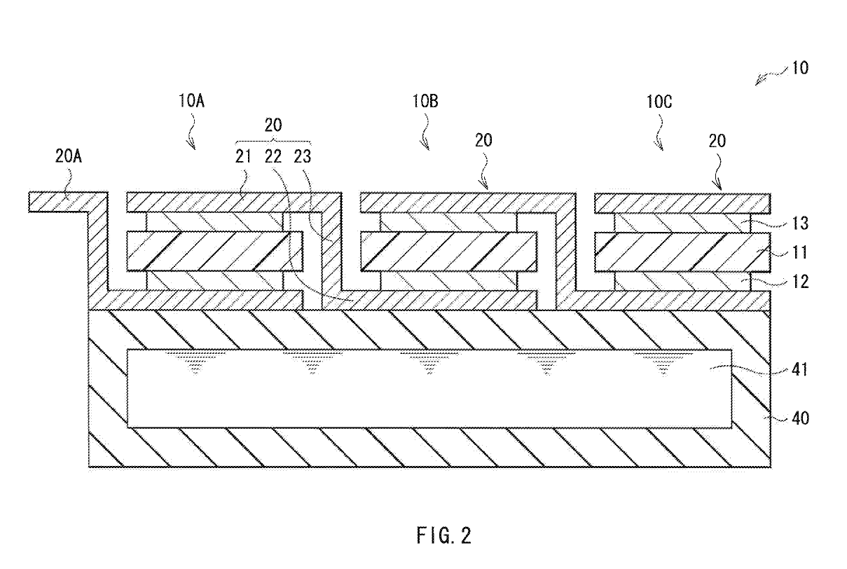

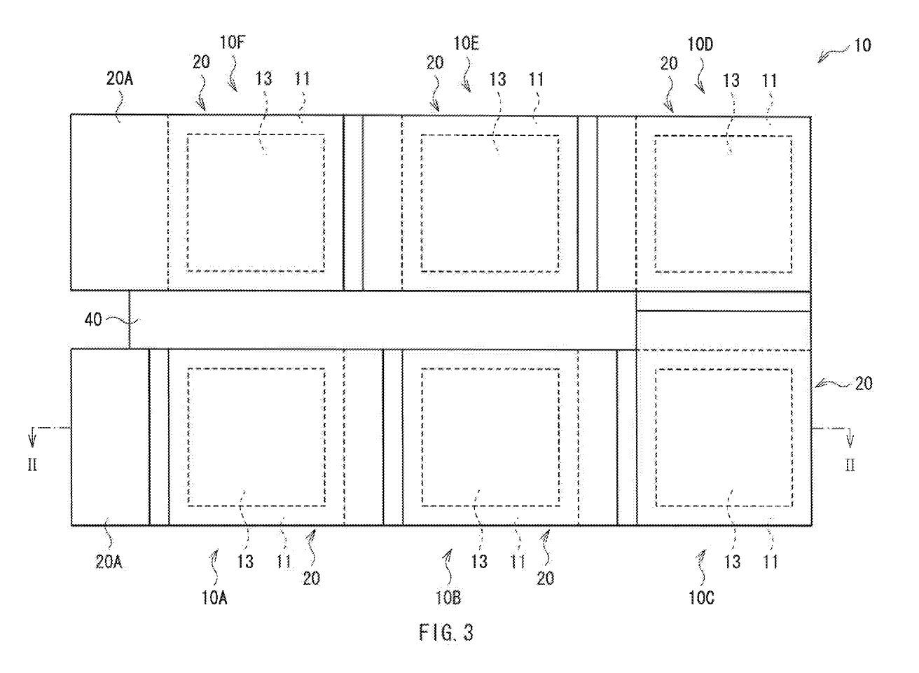

Next, a description will be given in detail of the power generation section 10 with reference to FIG. 2 and FIG. 3. FIG. 2 and FIG. 3 illustrate a structural example of unit cells 10A to 10F. FIG. 2 corresponds to a cross sectional structure taken along line II-II of FIG. 3. The unit cells 10A to 10F are arranged, for example, in a matrix of three by two in the in-plane direction, and has a planar laminated structure in which each thereof is electrically connected to each other in series by a plurality of connection members 20. The unit cells 10A to 10F are attached with a terminal 20A as an extension section of the connection members 20. Below the unit cells 10A to 10F, a fuel tank 40 to contain a liquid fuel (for example, methanol water) 41 is provided.

The respective unit cells 10A to 10F have a fuel electrode (anode, anode electrode) 12 and an oxygen electrode 13 (cathode, cathode electrode) that are oppositely arranged with an electrolyte film 11 in between.

The electrolyte film 11 is made of, for example, a proton conductive material having a sulfonate group (—SO₃H). Examples of proton conductive materials include a polyperfluoroalkyl sulfonic acid proton conductive material (for example, “Nafion (registered trademark),” Du Pont make), a hydrocarbon system proton conductive material such as polyimide sulfone acid, and a fullerene system proton conducive material.

The fuel electrode 12 and the oxygen electrode 13 have, for example, a structure in which a catalyst layer containing a catalyst such as platinum (Pt) and ruthenium (Ru) is formed on a current collector made of, for example, carbon paper. The catalyst layer is, for example, a layer in which a supporting body such as carbon black supporting a catalyst is dispersed in a polyperfluoroalkyl sulfonic acid proton conductive material or the like. An air supply pump (not illustrated) may be connected to the oxygen electrode 13. Otherwise, the oxygen electrode 13 may communicate with outside through an aperture (not illustrated) provided in the connection member 20, and air, that is, oxygen may be supplied therein by natural ventilation.

The connection member 20 has a bend section 23 between two flat sections 21 and 22. The flat section 21 is contacted with the fuel electrode 12 of one unit cell (for example, 10A), and the flat section 22 is contacted with the oxygen electrode 13 of an adjacent unit cell (for example, 10B), and thereby the adjacent two unit cells (for example, 10A and 10B) are electrically connected in series. Further, the connection member 20 has a function as a current collector to correct electricity generated in the respective unit cells 10A to 10F. Such a connection member 20 has, for example, a thickness of 150 μm, is composed of copper (Cu), nickel (Ni), titanium (Ti), or stainless steel (SUS), and may be plated with gold (Au), platinum (Pt) or the like. Further, the connection member 20 has an aperture (not illustrated) for respectively supplying fuel and air to the fuel electrode 12 and the oxygen electrode 13. The connection member 20 is made of, for example, mesh such as an expanded metal, a punching metal or the like. The bend section 23 may be previously bent according to the thickness of the unit cells 10A to 10F. Otherwise, in the case where the connection member 20 is made of a material having flexibility such as mesh having a thickness of 200 μm or less, the bend section 23 may be formed by being bent in a manufacturing step. Such a connection member 20 is jointed with the unit cells 10A to 10F by, for example, screwing a sealing material (not illustrated) such as PPS (polyphenylene sulfide) and silicon rubber provided around the electrolyte film 11 into the connection member 20.

The fuel tank 40 is composed of a container with a cubic volume changeable without intrusion of air bubbles or the like therein even if the liquid fuel 41 is increased or decreased (for example, a plastic bag), and a rectangular solid case (structure) to cover the container. The fuel tank 40 is provided with a fuel supply pump (not illustrated) for suctioning the liquid fuel 41 in the fuel tank 40 and exhausting the suctioned liquid fuel 41 from a nozzle (not illustrated) in a position above approximately center of the fuel tank 40. The liquid fuel exhausted from the nozzle is diffused by pressurization by the pump, capillary phenomenon or the like on a fuel diffusion plate (not illustrated) provided on the top face of the fuel tank 40, and is supplied to the respective unit cells 10A to 10F. The liquid fuel 41 in a vaporized state may be supplied to the unit cells 10A to 10F. Otherwise, the liquid fuel 41 in a liquid state may be contacted with the fuel electrode 12.

The fuel cell system 1 is able to be manufactured, for example, as follows.

First, the electrolyte film 11 made of the foregoing material is sandwiched between the fuel electrode 12 and the oxygen electrode 13 made of the foregoing material. The resultant is jointed by thermal compression bond. Thereby, the fuel electrode 12 and the oxygen electrode 13 are jointed with the electrolyte film 11 to form the unit cells 10A to 10F.

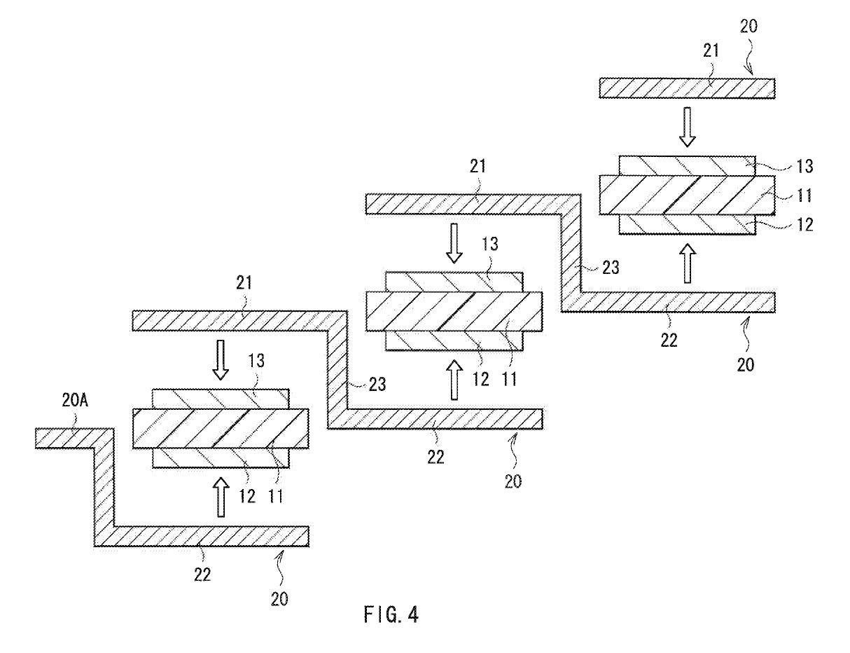

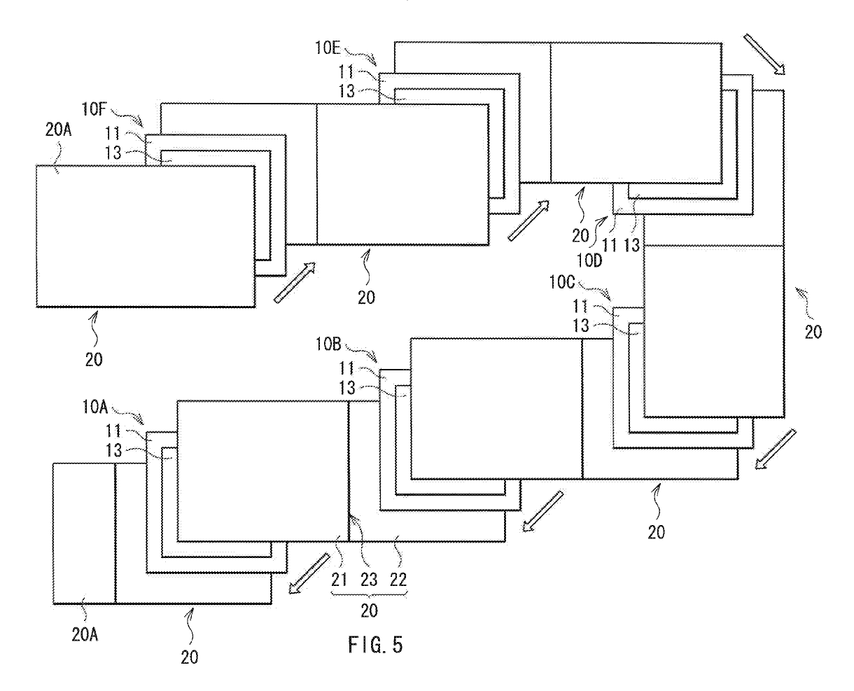

Next, the connection member 20 made of the foregoing material is prepared. As illustrated in FIG. 4 and FIG. 5, the six unit cells 10A to 10F are arranged in a matrix of three by two, and are electrically connected to each other in series by the connection member 20. The sealing material (not illustrated) made of the foregoing material is provided around the electrolyte film 11, and the sealing material is screwed and fixed on the bend section 23 of the connection member 20.

After that, the fuel tank 40 that contains the liquid fuel 41 and is provided with the fuel supply pump (not illustrated) or the like is arranged on the fuel electrode 12 side of the linked unit cells 10A to 10F, and thereby the power generation section 10 is formed. The foregoing voltage limitation circuit 3 is electrically connected in parallel to the power generation section 10. Accordingly, the fuel cell system 1 illustrated in FIG. 1 to FIG. 3 is completed.

In the fuel cell system 1, the fuel is supplied to the anode electrode 12 of the respective unit cells 10A to 10F, and reaction is initiated to generate protons and electrons. The protons are moved through the electrolyte film 11 to the oxide electrode 13, are reacted with electrons and oxygen to generate water. Thereby, part of chemical energy of the liquid fuel 41, that is, methanol is converted to electric energy, which is collected by the connection member 20 and is extracted as a current (output current I1) from the power generation section 10. The output current I1 and the electro motive force V1 by the power generation section 10 are supplied through the output terminals T1 and T2 to drive the load 5.

In the case where the electro motive force V1 by the power generation section 10 is a value equal to or less than the threshold voltage Vp at which elution of the cathode of the respective unit cells 10A to 10F is generated (V1≦Vp), as described above, the threshold voltage Vp is almost equal to the breakdown voltage Vz of the zener diode D1 in the voltage limitation circuit 3. Thus, an output current is not flown to the zener diode D1 side, and the output current I1 is directly supplied to the load 5 side. That is, in the case of V1≦Vp, there is no possibility that elution of the cathode of the respective unit cells 10A to 10F is generated by the electro motive force V1 by the power generation section 10. Thus, the electro motive force V1 is directly supplied to the load 5 side.

Meanwhile, in the case where the electro motive force V1 by the power generation section 10 exceeds the threshold voltage Vp (V1>Vp), to prevent elution of the cathode of the respective unit cells 10A to 10F, electric power based on a voltage ΔV (=V1−Vp) for an excess portion over the threshold voltage Vp is heat-consumed by the voltage limitation circuit 3. Specifically, since the electro motive force V1 exceeds the breakdown voltage Vz of the zener diode D1, due to the voltage ΔV for the excess portion over the threshold voltage Vp, as an output current 2 illustrated in FIG. 1, a current is flown to the zener diode D1. Thereby, electric power based on the voltage ΔV is heat-consumed by a resistance component of the zener diode D1 and is released outside. Therefore, the electro motive force V1 of the power generation section 10 is limited to the threshold voltage Vp or less.

Further, at the time of voltage limitation operation by the voltage limitation circuit 3, differently from the existing case, it is not necessary to constantly monitor the temperature of the power generation section 10, the fuel concentration of the liquid fuel 41, the electro motive force V1 by the power generation section 10 and the like. Thus, increase of electric power consumption at the time of power generation resulting from such voltage limitation operation is not caused.

As described above, in this embodiment, in the case where the electro motive force V1 by the power generation section 10 exceeds the given threshold voltage Vp at which elution of the cathode of the respective unit cells 10A to 10F is generated, the electric power based on the voltage ΔV for the excess portion over the threshold voltage Vp is heat-consumed in the voltage limitation circuit 3. Thereby, the electro motive force V1 of the power generation section 10 is limited to the threshold voltage Vp or less. In result, elution of the cathode of the respective unit cells 10A to 10F due to excessive electro motive force is able to be inhibited without increase of electric power consumption at the time of power generation.

Specifically, the voltage limitation circuit 3 includes a rectifier. The cathode of the rectifier is connected to the cathode side of the power generation section 10, and the anode of the rectifier is connected to the anode side of the power generation section 10. Thus, elution of the cathode of the respective unit cells 10A to 10F due to excessive electro motive force is able to be inhibited without increase of electric power consumption at the time of power generation as described above.

Further, the rectifier is composed of one zener diode D1. Thus, the breakdown voltage of the rectifier is able to be precisely determined, and strict voltage limitation operation is enabled.

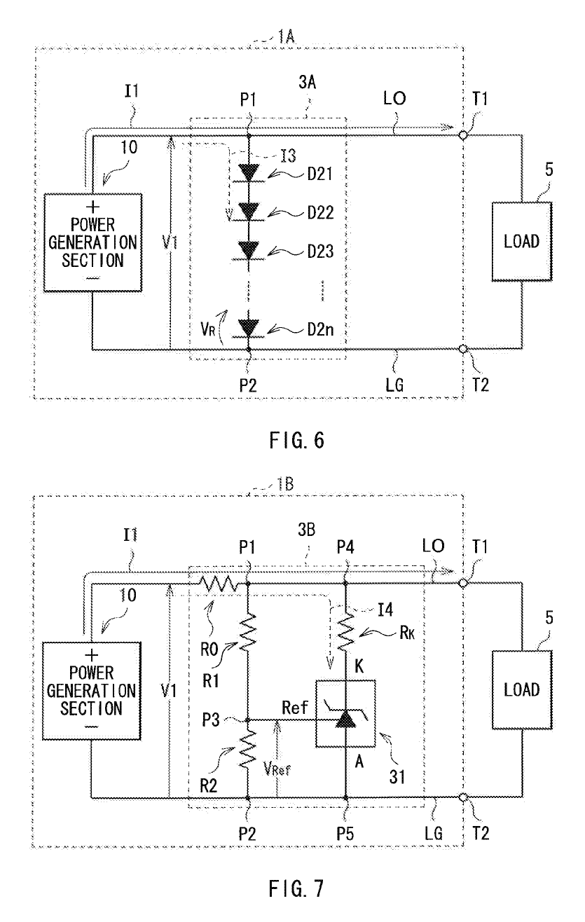

For example, as a voltage limitation circuit 3A in a fuel cell system 1A illustrated in FIG. 6, the rectifier in the voltage limitation circuit may be composed of a plurality of diodes D21 to D2n directly connected to each other electrically. Specifically, the respective diodes D21 to D2n may be arranged so that the anode is opposed to the cathode side (connection point P1 side) of the power generation section 10, and the cathode is opposed to the anode side (connection point P2 side) of the power generation section 10. Further, the total of voltage drop VR of the respective diodes D21 to D2n is set almost equal to the threshold voltage Vp. In the voltage limitation circuit 3A having such a structure, in the case where the electro motive force V1 by the power generation section 10 exceeds the threshold voltage Vp (V1>Vp), as an output current I3 illustrated in the figure, a current is flown toward the respective diodes D21 to D2n, and thereby electric power based on the voltage ΔV is heat-consumed by a resistance component of the respective diodes D21 to D2n and released outside. Thus, by action similar to that of this embodiment, similar effect is obtained. Further, since the rectifier is composed of the plurality of diodes, a leakage current in the rectifier is able to be small.

### Second Embodiment

Next, a description will be given of a second embodiment of the present invention. For the same elements as those in the first embodiment, the same referential symbols are affixed and the description thereof will be omitted as appropriate.

FIG. 7 illustrates a whole structure of a fuel cell system (fuel cell system 1B) according to this embodiment. The fuel cell system 1B is similar to the fuel cell system 1 in the first embodiment illustrated in FIG. 1, except that a voltage limitation circuit 3B is provided instead of the voltage limitation circuit 3.

The voltage limitation circuit 3B is electrically connected in parallel to the power generation section 10, and is composed of a shunt regulator 31, resistors R0 and Rk, and resistors R1 and R2 structuring a first resistance voltage divider. Specifically, the shunt regulator 31 is arranged so that the cathode is opposed to the cathode side (connection point P4 side) of the power generation section 10 and the anode is opposed to the anode side (connection point P5 side) of the power generation section 10. Further, a reference terminal of the shunt regulator 31 is connected to the connection point P3. Further, the resistors R1 and R2 are electrically connected to each other in series between the connection points P1 and P2, and are connected in parallel to the power generation section 10 and the shunt regulator 31. The resistors R1 and R2 function as the first resistance voltage divider that supplies a divided voltage (reference voltage Vref=V1*(r2/(r1+r2), r1 and r2 are resistance values of the resistors R1 and R2) of the electro motive force V1 by the power generation section 10 to the reference terminal of the shunt regulator 31. Further, the resistor R0 is arranged between the cathode side of the power generation section 10 and the cathode of the shunt regulator 31 (inserted between the cathode of the power generation section 10 and the connection point P1). The resistor Rk is connected in parallel to the power generation section 10 and the foregoing first resistance voltage divider, and is connected in series to the shunt regulator 31 (inserted between the connection point P 4 and the cathode of the shunt regulator). The foregoing electro motive force V1 is almost equal to the threshold voltage Vp, and is, for example, 0.33 V per unit cell.

In the fuel cell system 1B, in the case where the electro motive force V1 by the power generation section 10 is a value equal to or less than the threshold voltage Vp at which elution of the cathode of the respective unit cells 10A to 10F is generated (V1≦Vp), the divided voltage (reference voltage Vref) of the electro motive force V1 supplied to the reference terminal of the shunt regulator 31 is lower than an operation voltage of the shunt regulator 31. Thus, the output current is not flown to the shunt regulator 31 side, and the output current I1 is directly supplied to the load 5 side. That is, in the case of V1≦Vp, there is no possibility that elution of the cathode of the respective unit cells 10A to 10F is generated by the electro motive force V1 by the power generation section 10. Thus, the electro motive force V1 is directly supplied to the load 5 side.

Meanwhile, in the case where the electro motive force V1 by the power generation section 10 exceeds the threshold voltage Vp (V1>Vp), to prevent elution of the cathode of the respective unit cells 10A to 10F, electric power based on a voltage ΔV (=V1−Vp) for the excess portion over the threshold voltage Vp is heat-consumed by the voltage limitation circuit 3B. Specifically, since the divided voltage of the electro motive force V1 (reference voltage Vref) is higher than the operation voltage of the shunt regulator 31, the shunt regulator 31 becomes in ON state. Therefore, due to the voltage ΔV for the excess portion over the threshold voltage Vp, as an output current I4 illustrated in FIG. 7, a current is flown to the shunt regulator 31. Thereby, electric power based on the voltage ΔV is heat-consumed by a resistance component of the shunt regulator 31 and is released outside. Therefore, the electro motive force V1 of the power generation section 10 is limited to the threshold voltage Vp or less.

As described above, in this embodiment, by action similar to that of the first embodiment, similar effect is able to be obtained. That is, elution of the cathode of the respective unit cells 10A to 10F due to excessive electro motive force is able to be inhibited without increase of electric power consumption at the time of power generation.

Specifically, since the voltage limitation circuit 3B includes the shunt regulator 31, the cathode of the shunt regulator 31 is opposed to the cathode side of the power generation section 10, and the anode is opposed to the anode side of the power generation section 10, the foregoing effect is able to be obtained.

Further, the voltage limitation circuit 3B has the first resistance voltage divider (composed of the resistors R1 and R2) that is electrically connected in parallel to the power generation section 10 and the shunt regulator 31, and supplies the divided voltage (reference voltage Vref) of the electro motive force V1 by the power generation section 10 to the reference terminal of the shunt regulator 31. Thus, the operation voltage based on the threshold voltage Vp is able to be supplied to the reference terminal of the shunt regulator 31.

Further, the voltage limitation circuit 3B has the resistor R0 (first resistor) between the cathode side of the power generation section 10 and the cathode of the shunt regulator 31. Thus, size of the current I3 flown to the shunt regulator 31 is able to be limited.

Further, the voltage limitation circuit 3B has the resistor Rk (second resistor) that is connected in parallel to the power generation section 10 and the first resistance voltage divider and is connected in series to the shunt regulator 31. Thus, at the time of voltage limitation operation, operation to convert the electric power based on the current I3 to heat is able to be performed by both the shunt regulator 31 and the resistor Rk.

In some cases, it is possible that the foregoing resistors R0 and Rk are not provided in the voltage limitation circuit.

### Third Embodiment

Next, a description will be given of a third embodiment of the present invention. For the same elements as those in the first and the second embodiments, the same referential symbols are affixed and the description thereof will be omitted as appropriate.

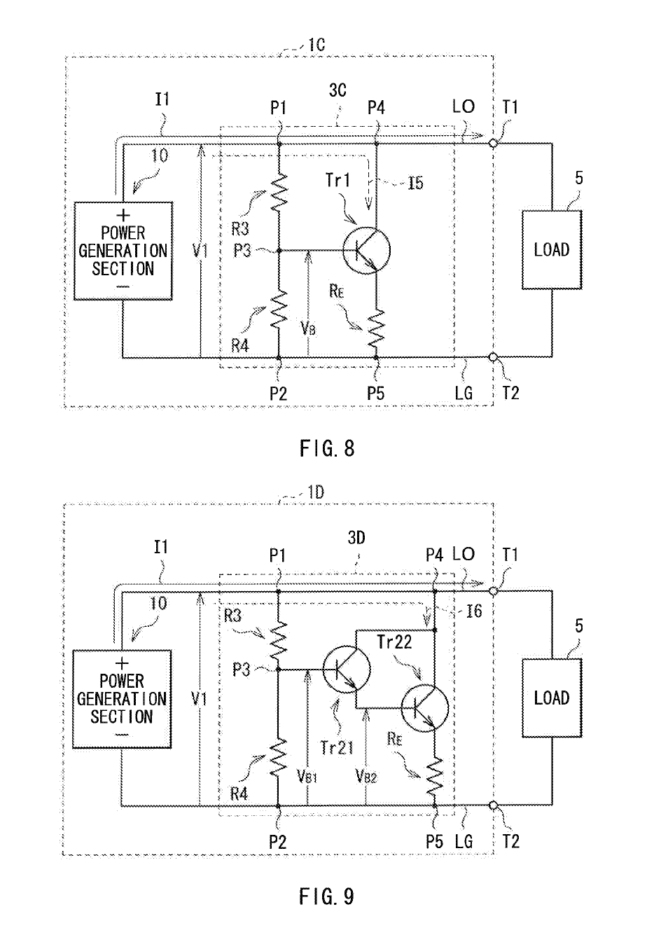

FIG. 8 illustrates a whole structure of a fuel cell system (fuel cell system 1C) according to this embodiment. The fuel cell system 1C is similar to the fuel cell system 1 in the first embodiment illustrated in FIG. 1, except that a voltage limitation circuit 3C is provided instead of the voltage limitation circuit 3.

The voltage limitation circuit 3C is electrically connected in parallel to the power generation section 10, and is composed of an NPN transistor Tr1 as a bipolar transistor, a resistor RE, and resistors R3 and R4 structuring a second resistance voltage divider. Specifically, the NPN transistor Tr1 is electrically connected in series to the resistor Rk (third resistor), and is electrically connected in parallel to the power generation section 10. Further, regarding the NPN transistor Tr1, its base is connected to the connection point P3, its emitter is connected to the connection point P5 side (one end of the resistor RE), and its collector is connected to the connection point P4. Further, the resistors R3 and R4 are connected electrically in series between the connection points P1 and P2, and are connected in parallel to the power generation section 10 and the NPN transistor Tr1. The resistors R3 and R4 function as the second resistance voltage divider that supplies a divided voltage (base voltage VB=V1*(r4/(r3+r4), r3 and r4 are resistance values of the resistors R3 and R4) of the electro motive force V1 by the power generation section 10 to a base terminal of the NPN transistor Tr1. Further, regarding the resistor RE, one end is connected to the emitter of the NPN transistor, and the other end is connected to the connection point P5. The foregoing electro motive force V1 is almost equal to the threshold voltage Vp, and is, for example, 0.33 V per unit cell. The NPN transistor Tr1 corresponds to a specific example of “transistor” in the present invention.

In the fuel cell system 1C, in the case where the electro motive force V1 by the power generation section 10 is a value equal to or less than the given threshold voltage Vp at which elution of the cathode of the respective unit cells 10A to 10F is generated (V1≦Vp), the divided voltage (base voltage VB) of the electro motive force V1 supplied to the base terminal of the NPN transistor Tr1 is lower than an ON voltage of the NPN transistor Tr1. Thus, an output current is not flown to the NPN transistor Tr1 side, and the output current I1 is directly supplied to the load 5 side. That is, in the case of V1≦Vp, there is no possibility that elution of the cathode of the respective unit cells 10A to 10F is generated by the electro motive force V1 by the power generation section V1. Thus, the electro motive force V1 is directly supplied to the load 5 side.

Meanwhile, in the case where the electro motive force V1 by the power generation section 10 exceeds the threshold voltage Vp (V1>Vp), to prevent elution of the cathode of the respective unit cells 10A to 10F, electric power based on the voltage ΔV (=V1−Vp) for the excess portion over the threshold voltage Vp is heat-consumed by the voltage limitation circuit 3C. Specifically, since the divided voltage of the electro motive force V1 (base voltage VB) is higher than the ON voltage of the NPN transistor Tr1, the NPN transistor Tr1 becomes in ON state. Therefore, due to the voltage ΔV for the excess portion over the threshold voltage Vp, as an output current I5 illustrated in FIG. 7, a current is flown to the NPN transistor Tr1 and the resistor RE. Thereby, electric power based on the voltage ΔV is heat-consumed by the resistor RE and is released outside. Therefore, the electro motive force V1 of the power generation section 10 is limited to the threshold voltage Vp or less.

As described above, in this embodiment, by action similar to that of the first and the second embodiments, similar effect is able to be obtained. That is, elution of the cathode of the respective unit cells 10A to 10F due to excessive electro motive force is able to be inhibited without increase of electric power consumption at the time of power generation.

Specifically, the voltage limitation circuit 3C has the NPN transistor Tr1 and the resistor RE3 that are connected in series to each other and that are connected in parallel to the power generation section 10, and the second resistance voltage divider (composed of the resistors R3 and R4) that is connected in parallel to the power generation section 10 and supplies a divided voltage of the electro motive force V1 by the power generation section 10 to switch between ON operation and OFF operation of the NPN transistor Tr1. Thus, the foregoing effect is able to be obtained.

For example, as a fuel cell system 1D illustrated in FIG. 9, a voltage limitation circuit 3D may have a plurality of bipolar transistors (in this case, two NPN transistors Tr21 and Tr22 determined by base voltages VB1 and VB2), and the plurality of bipolar transistors may be compositively connected to each other (Darlington connection). In the case of such a structure, a current (current I6) flown into the transistor at the time of voltage limitation operation is able to be larger than the current I5 described in this embodiment, and voltage limitation operation is able to be more effectively performed.

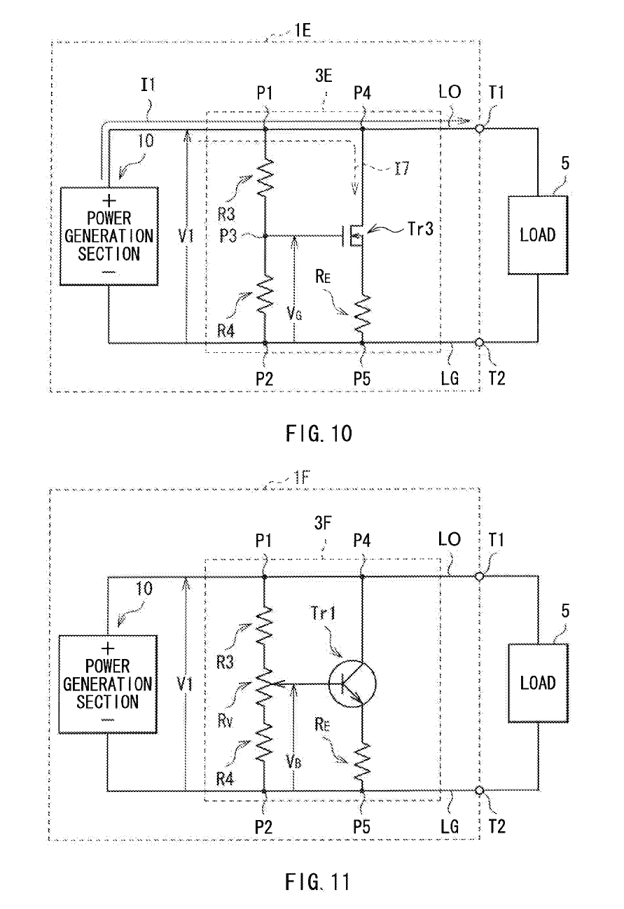

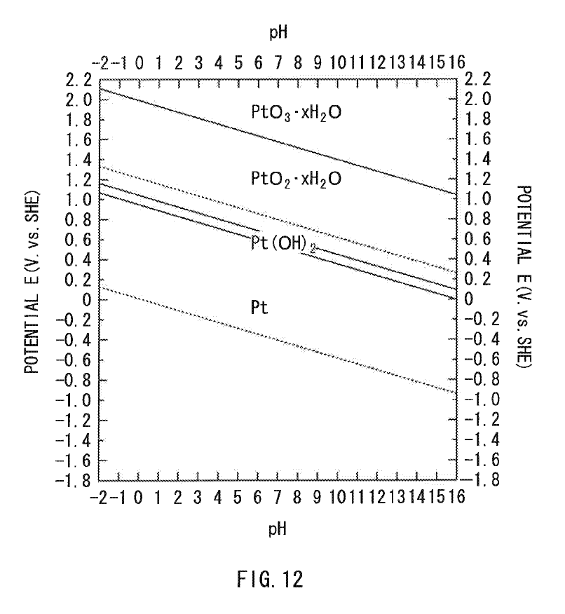

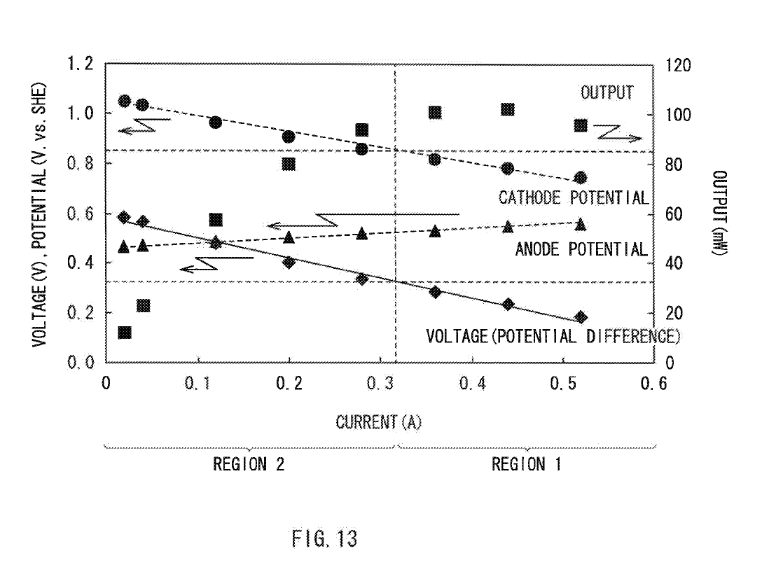

Further, for example, as a fuel cell system 1E illustrated in FIG. 10, in a voltage limitation circuit 3E, a transistor may be a field-effect transistor (in this case, N channel FET) Tr3, and the field-effect transistor Tr3 may be arranged so that a divided voltage by the second resistance voltage divider (gate voltage VG) is supplied to a gate terminal. In the case of such a structure, a current consumption in the voltage limitation circuit (current consumption by a current I7 in the figure) is able to be smaller than that in the case of the bipolar transistor described in this embodiment.

Further, for example, as a fuel cell system 1F illustrated in FIG. 11, a voltage limitation circuit 3F may have a variable resistor Rv capable of adjusting a size of a divided voltage (base voltage VB) by the second resistance voltage divider. Specifically, the variable resistor Rv is inserted between the resistors R3 and R4. In this case, the base voltage VB is expressed as VB=V1(Vp)*((r4+rv4)/(r3+rv3+r4+rv4)) (rv3 and rv4 are divided resistance values on the resistor R3 side or the resistor R4 side out of the resistance values of the variable resistor Rv). In the case of such a structure, the set value of the base voltage VB is able to be more finely adjusted. Such a variable resistor Rv may be provided in the voltage limitation circuits 3D and 3E illustrated in FIG. 9 and FIG. 10.

While in this embodiment and the modified examples thereof, the description has been given of the case that the transistor is the NPN transistor or the N channel FET. However, the transistor may be a PNP transistor or a P channel FET.

The present invention has been described with reference to the first to the third embodiments. However, the present invention is not limited to these embodiments, and various modifications may be made.

For example, in the foregoing embodiments, the description has been given of the case that the power generation section 10 includes the six unit cells that are electrically connected to each other in series, the number of unit cells is not limited thereto. For example, the power generation section 10 may be composed of one unit cell, or may be composed of two or more given plurality of unit cells.

Further, in the foregoing embodiments, the description has been given of the direct methanol fuel cell system. However, the present invention is able to be also applied to other type of fuel cell system.

The fuel cell system of the present invention is able to be suitably used for a mobile electronic device such as a mobile phone, an electronic camera, an electronic databook, and a PDA (Personal Digital Assistants).

1. A fuel cell system comprising:
a power generation section including a unit cell having a cathode (oxygen electrode) and an anode (fuel electrode); and
a voltage limitation circuit that is connected in parallel to the power generation section, and in the case where electro motive force by the power generation section exceeds a given threshold voltage at which elution of the cathode is generated, heat-consumes electric power based on a voltage for an excess portion over the threshold voltage, and thereby limits the electro motive force of the power generation section to the threshold voltage or less.

2. The fuel cell system according to claim 1, wherein where a power generation potential of the anode is x [V vs. SHE], the threshold voltage is (0.85−x)[V] or less per unit cell.

3. The fuel cell system according to claim 2, wherein the unit cell is composed of a hydrogen fuel cell, and
the threshold voltage is 0.85 [V] or less per unit cell.

4. The fuel cell system according to claim 2, wherein the unit cell is composed of a direct methanol fuel cell, and
the threshold voltage is 0.33 [V] or less per unit cell.

5. The fuel cell system according to claim 1, wherein the voltage limitation circuit includes a zener diode, and
a cathode of the zener diode is connected to the cathode side of the power generation section, and an anode of the zener diode is connected to the anode side of the power generation section.

6. The fuel cell system according to claim 1, wherein the voltage limitation circuit includes a plurality of diodes connected to each other in series, and
the respective diodes are arranged so that each anode is opposed to the cathode side of the power generation section and each cathode is opposed to the anode side of the power generation section.

7. The fuel cell system according to claim 1, wherein the voltage limitation circuit includes a shunt regulator, and
the shunt regulator is arranged so that a cathode is opposed to the cathode side of the power generation section and an anode is opposed to the anode side of the power generation section.

8. The fuel cell system according to claim 7, wherein the voltage limitation circuit has a first resistance voltage divider that is connected in parallel to the power generation section and the shunt regulator and supplies a divided voltage of the electro motive force by the power generation section to a reference terminal of the shunt regulator.

9. The fuel cell system according to claim 8, wherein the voltage limitation circuit has a first resistor between the cathode side of the power generation section and the cathode of the shunt regulator.

10. The fuel cell system according to claim 8, wherein the voltage limitation circuit has a second resistor that is connected in parallel to the power generation section and the first resistance voltage divider and is connected in series to the shunt regulator.

11. The fuel cell system according to claim 1, wherein the voltage limitation circuit has:
a transistor and a third resistor that are connected in series to each other and that are connected in parallel to the power generation section; and
a second resistance voltage divider that is connected in parallel to the power generation section and supplies a divided voltage of the electro motive force by the power generation section to switch between ON operation and OFF operation of the transistor.

12. The fuel cell system according to claim 11, wherein the transistor is a bipolar transistor, and
the bipolar transistor is arranged so that the divided voltage by the second resistance voltage divider is supplied to a base terminal.

13. The fuel cell system according to claim 12, wherein the voltage limitation circuit has a plurality of the bipolar transistors, and
the plurality of the bipolar transistors are compositively connected to each other (Darlington connection).

14. The fuel cell system according to claim 11, wherein the transistor is a field-effect transistor (FET), and
the field-effect transistor is arranged so that the divided voltage by the second resistance voltage divider is supplied to a gate terminal.

15. The fuel cell system according to claim 11, wherein the voltage limitation circuit has a variable resistor capable of adjusting a size of the divided voltage by the second resistance voltage divider.

16. The fuel cell system according to claim 1, wherein the power generation section includes a plurality of the unit cells that are electrically connected to each other in series.

17. A voltage limitation method applied to a fuel cell system that includes a power generation section including a unit cell having a cathode (oxygen electrode) and an anode (fuel electrode), wherein
with the use of a voltage limitation circuit that is connected in parallel to the power generation section, in the case where electro motive force by the power generation section exceeds a given threshold voltage at which elution of the cathode is generated, electric power based on a voltage for an excess portion voltage over the threshold voltage is heat-consumed, and thereby the electro motive force of the power generation section is limited to the threshold voltage or less.
